(19) United States
(12) Patent Application Publication
(10) Pub. No.: US 2013/0278439 A1
(43) Pub. Date: Oct. 24, 2013

(54) COMMUNICATION BETWEEN A SENSOR AND A PROCESSING UNIT OF A METAL DETECTOR

(71) Applicant: Minelab Electronics Pty Limited, Torrensville (AU)

(72) Inventors: Laurentiu STAMATESCU, Torrensville (AU); Dorin Lucian BORDEAN, Torrensville (AU); Philip David BECK, Torrensville (AU); Mark Brian LAURIE, Torrensville (AU)

(73) Assignee: MINELAB ELECTRONICS PTY LIMITED

(21) Appl. No.: 13/923,162

(22) Filed: Jun. 20, 2013

Related U.S. Application Data
(63) Continuation of application No. PCT/AU2011/001676, filed on Dec. 22, 2011.

(30) Foreign Application Priority Data
Dec. 24, 2010 (AU) 2010905661

(51) Int. Cl. G08C 19/00

(52) U.S. Cl. CPC G08C 19/00
USPC 340/870.31

(57) ABSTRACT

A method for improving a performance of a metal detector, including: generating a transmit signal; generating a transmit magnetic field based on the transmit signal for transmission using a magnetic field transmitter; sending a receive signal based on a receive magnetic field received by a magnetic field receiver to a processing unit of the metal detector; sending a communication signal, including information from a sensor, to the processing unit; and processing the receive signal with the communication signal to produce an indicator output signal indicating a presence of a target under an influence of the transmit magnetic field; wherein one or more characteristics of the communication signal are selected based on the transmit signal to reduce or avoid an interference of the communication signal to the receive signal.

### CROSS-REFERENCE TO RELATED APPLICATION

This application is a Continuation of International Application No. PCT/AU2011/001676 filed on Dec. 22, 2011, which claims benefit of Australian Provisional Patent Application No. 2010905661 titled “Metal Detector” filed on Dec. 24, 2010. The entire contents of each application noted above are hereby incorporated by reference.

### FIELD OF THE INVENTION

This invention relates to a metal detector which has one or more additional sensors attached to the sensing head of the metal detector.

### BACKGROUND OF THE INVENTION

Metal detectors are used to determine/detect the location of conductive objects that are buried in the ground. Examples of such objects include coins, relics, gold, mines and minerals.

Modern metal detectors can be broadly classified as frequency domain or time domain. Frequency domain metal detectors include continuous waveform (CW) or very low frequency (VLF) detectors, while time domain metal detectors include pulse induction (PI) detectors.

A typical metal detector operates by transmitting electromagnetic energy into the ground (commonly referred to as primary field) where it interacts with a buried object, which in turn generates and transmits electromagnetic energy (commonly referred to as secondary field). The sensing head of a metal detector, which includes a transmitter and a receiver, is used to receive and measure the electromagnetic energy from the buried object (secondary field) to detect the presence of a buried object from the ground. A typical method for metal detection using a metal detector is to move the sensing head of the metal detector back and forth over the ground to sweep an area of interest.

Advancements in the field of miniature and portable electronics have opened up the possibility of having one or more sensors, or having one or more types of sensor (position sensor, motion sensor etc) with various functionalities embedded in the sensing head of the metal detector, or located near the sensing head of the metal detector. Information provided by the one or more sensors, or one or more types of sensor can be used to improve the performance of the metal detector in detecting ferrous and/or conductive objects.

The one or more sensors require power from, and communications with, the metal detector itself. Often, there are minimal physical and/or wireless connections between the sensors and the metal detector for maintaining cost requirements to a practical level. However, one of the problems brought about by such communications, in particular if the communications have to occur continuously and concurrently with the processing of the receive signal, is that it has the potential to interfere with the operation of the metal detector. In particular, since the receive signal received by the metal detector is often at the nano-volt level, while the communications are at the volt level, the possibility of interference is very real.

When a sensing head of a metal detector (or a sensing head in the proximity of the metal detector) includes sensors (e.g. micro-controllers, accelerometers, gyroscopes etc) with activities unrelated to the operation of the metal detector for receiving and processing a receive signal due to the secondary field, the signals from the sensors can couple into the signal path of the receive signal within the metal detector. The coupling mechanism can be of the conducted type, like through power and ground connections, or of the non-conducted type, like capacitive or inductive coupling. Once the coupled signals reach into the signal path of the receive signal, they can add to or mix with the receive signal, creating either broadband noise or beating interference. Either type will degrade the performance of the metal detector, which is unlikely to be compensated by the improvement created by the additional sensor(s).

This invention provides a means and method of reducing or avoiding this interference and allowing optimal metal detector operation with the added benefits from the sensor(s) embedded in or located near the sensing head of a metal detector.

### SUMMARY OF THE INVENTION

According to an aspect of the present invention, there is provided a method for improving a performance of a metal detector, including: generating a transmit signal; generating a transmit magnetic field based on the transmit signal for transmission using a magnetic field transmitter; sending a receive signal based on a receive magnetic field received by a magnetic field receiver to a processing unit of the metal detector; sending a communication signal, including information from a sensor, to the processing unit; and processing the receive signal with the communication signal to produce an indicator output signal indicating a presence of a target under an influence of the transmit magnetic field; wherein one or more characteristics of the communication signal are selected based on the transmit signal to reduce or avoid an interference of the communication signal to the receive signal.

In one form, the one or more characteristics of the communication signal include a starting time of the communication signal.

In one form, the transmit signal defines a suitable period for the step of sending the communication signal to the processing unit to reduce the interference of the communication signal to the receive signal, and wherein the starting time of the communication signal is within the suitable period.

In one form, the one or more characteristics of the communication signal includes an ending time of the communication signal, and wherein the ending time of the communication signal is within the suitable period.

In one form, during the suitable period, the processing unit is not processing the receive signal.

In one form, the transmit signal includes a transmit period and a zero-transmit period; and the processing unit processes the receive signal during a part of the zero-transmit period.

In one form, the zero-transmit period includes the suitable period.

In one form, the transmit period includes a low-voltage period and a high-voltage period; and the low-voltage period includes the suitable period.

In one form, the transmit signal includes a voltage period of a first polarity and a voltage period of a second polarity, the second polarity is opposite the first polarity; and the processing unit processes the receive signal after a predetermined delay from the transition of the voltage period of one polarity to the voltage period of opposite polarity.

In one form, the predetermined delay includes the suitable period.

In one form, the transmit signal includes a high-voltage period and a low-voltage period; and the processing unit processes the receive signal during a part of the low-voltage period after a predetermined delay from the transition of the high-voltage period to the low-voltage period

In one form, the high-voltage period includes the suitable period.

In one form, the low-voltage period includes the suitable period.

In one form, the processing unit processes the receive signal using a continuous synchronous demodulation function which includes a positive demodulation window and a negative demodulation window; and wherein a period about a transition of a demodulation window to another includes the suitable period.

In one form, the suitable period overlaps substantially the same duration with the positive demodulation window and the negative demodulation window.

In one form, the one or more characteristics of the communication signal includes characteristics of one or more predominant frequency components of the communication signal.

In one form, one or more of the predominant frequency components of the transmit signal are at frequencies different from that of predominant frequency components of the communication signal.

In one form, harmonics of the predominant frequency components of the transmit signal are at frequencies different from that of harmonics of the predominant frequency components of the communication signal.

In one form, the method further including the step of: updating a state of the communication signal during a suitable period defined by the transmit signal to reduce an interference caused by the updating to the receive signal.

According to another aspect of the present invention, there is provided metal detector configurable to perform the first aspect, and/or its various forms.

To assist with the understanding of this invention, reference will now be made to the drawings:

### BRIEF DESCRIPTION OF THE DRAWINGS

FIG. 1 depicts a functional block diagram showing the main parts of one embodiment of a metal detector having one or more sensors;

FIGS. 2a, 2b and 2c depict embodiments of the present invention where the transmit signal of a metal detector allows communication signals representing meaningful information or instructions to be sent in single or burst-forms between one or more sensors and the processing unit of the metal detector;

FIG. 3 depicts embodiments of the present invention where the transmit signal allows the communication signals to be sent over many short intervals;

FIG. 4 depicts another embodiment of the present invention where the transmit signal allows the communication signals to be sent over many short intervals;

FIG. 5 depicts one embodiment of the present invention where the transmit signal allows communication signals to be sent concurrently with the processing of the receive signal; and

FIG. 6 depicts another embodiment of the present invention where the transmit signal allows communication signals to be sent concurrently with the processing of the receive signal.

### DETAILED DESCRIPTION OF THE PREFERRED EMBODIMENTS

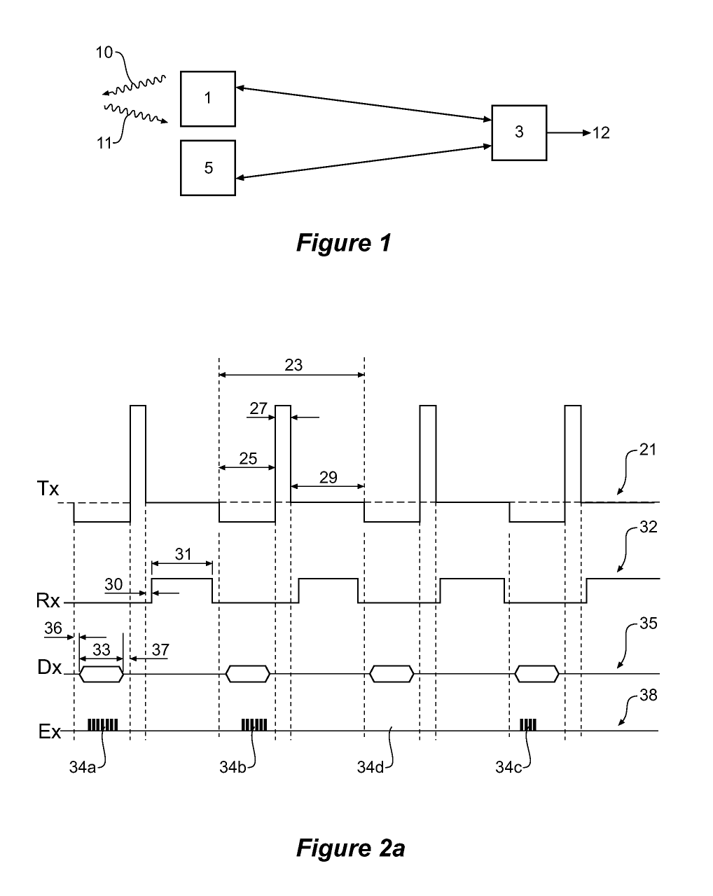

FIG. 1 is a functional block diagram showing the main parts of a metal detector having one or more sensors. The metal detector includes a sensing head 1, which includes a magnetic field transmitter and a magnetic field receiver (not shown), to transmit a transmit magnetic field 10 and to receive a receive magnetic field 11 respectively. The magnetic field transmitter and the magnetic field receiver can be separate coils, or can be the same coil, within the sensing head 1. The magnetic field transmitter and the magnetic field receiver can also be in any form and shape known to, and deemed suitable by, a person skilled in the art.

Processing unit 3, which includes transmit and receive electronics, produces a transmit signal. In one embodiment, the transmit signal is a repeating transmit signal cycle. The magnetic field transmitter within the sensing head 1, upon receiving the transmit signal, generates the transmit magnetic field 10.

The receive signal generated by the receive magnetic field 11 received by the sensing head 1, may be amplified and filtered prior to being processed by the processing unit 3 to produce an indicator output signal 12 indicating a presence of a target under the influence of the transmit magnetic field 10.

Additional sensor(s) 5 provides extra functions to, or enhances signal processing by, processing unit 3. For example, a movement sensor or a position sensor can be attached to the sensing head 1 of a metal detector to provide extra information regarding the secondary field/receive field, or a receive signal due to the secondary field/receive field. The extra information can be used to improve the performance of the metal detector, and to improve the interaction between the detector and the user, which improves the performance of the overall detecting process. The sensor(s) 5 need not be necessarily attached to the sensing head 1 and may be located at a position near the sensing head 1 or near both the sensing head 1 and the metal detector. The sensor(s) 5 can be physically or wirelessly connected to the processing unit 3.

In an embodiment, the motion sensor includes one or more of, but is not limited to, an accelerometer and/or a gyrometer, acoustic, optic or RF sensing, or measuring system or device.

In another embodiment, the position sensor includes one or more of, but is not limited to, a Global Positioning System (GPS) device.

The communication between the additional sensor(s) 5 and the signal processing unit 3 is often, but not necessarily, in digital serial form, as it requires few connections, yet it offers sufficient bandwidth for metal detection application. Serial form communication is also well supported in digital devices and it is economical (especially when physical connections are required).

There are many protocols and/or standards for serial communications (RS232, RS485, SPI, USB, I²C, ISS etc). While the need to keep the number of connections to a minimum would favour those serial standards which operate in half-duplex mode, and which do not require framing signals (like RS232 and related or I²C), the present invention is applicable to many types of communication using many kinds of protocols and/or standards. However, due to the need to synchronise the communication between the additional sensor(s) 5 and the signal processing unit 3 to other signals (such as a repeating transmit signal cycle), it is preferable to use a protocol and/or standard which does not have rigid clocking requirements.

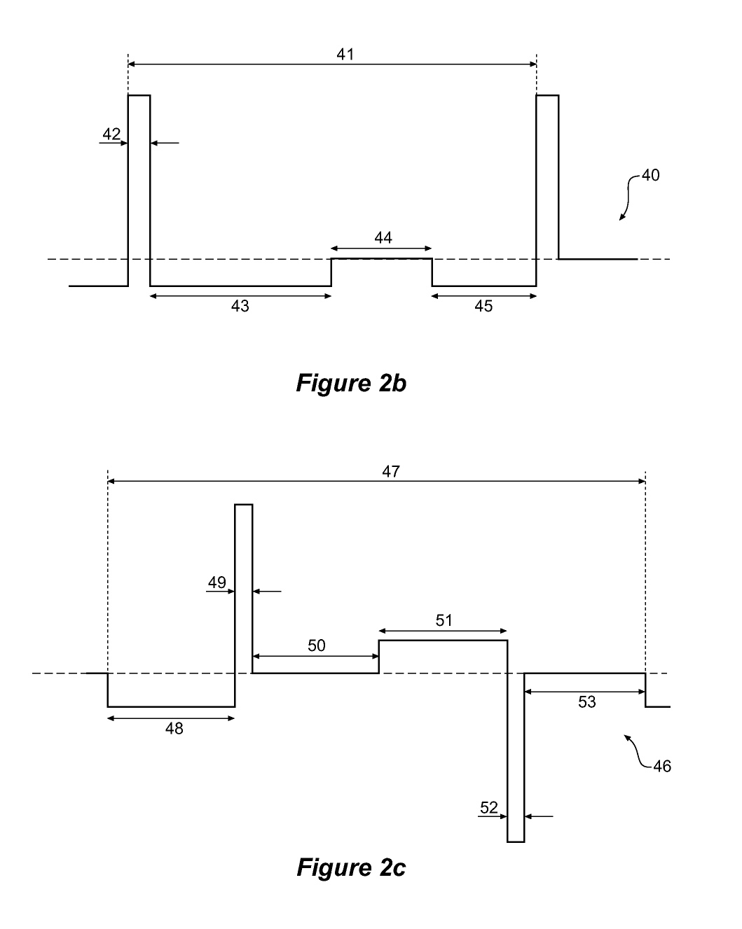

FIG. 2a depicts one embodiment of the present invention; the top waveform being the transmit signal (a repeating transmit signal cycle 21) of a time domain metal detector; the middle waveform 32 illustrating the time during which receive signals are received from the sensing head 1 and processed by the processing unit 3; waveform 35 illustrating the suitable period for communicating communication signals between additional sensor(s) 5 and processing unit 3; and waveform 38 showing an example of data communications occurring in the suitable periods defined by waveform 35.

With reference to FIG. 2a, a metal detector transmits a repeating transmit signal cycle 21 with a fundamental period 23. Each fundamental period 23 includes a low-voltage period 25, a high-voltage period 27 and a zero-voltage period 29. The voltage during the low-voltage period 25 is of a different polarity to the voltage during the high-voltage period 27. It is possible, but not necessary, to adjust the duration and/or the magnitude of the low-voltage period 25 and the duration and/or magnitude of the high-voltage period 27 such that the current through the transmitter is increasing in negative sense throughout the low-voltage period 25, increasing in positive sense throughout the high-voltage period 27, and that the current is substantially zero during the zero-voltage period 29. A period with zero current through the transmitter is also known as a zero-transmit period (in this case, the zero-voltage period 29 is such a zero-transmit period, and thus the low-voltage period 25 and the high-voltage period 27 may be known as transmit periods). The processing of the receive signal, which includes a demodulation of the receive signal, occurs after a short delay 30 from the end of the high-voltage period 27 as indicated by windows 31. The delay 30 is provided to allow some time for the receive coil circuit (within sensing head 1) and/or electronics (within processing unit 3) to settle after the transition from high-voltage period 27 (which is a transmit period) to zero-voltage period 29 (which is a zero-transmit period), and to avoid undesirable fast decaying signals (e.g. from saline environments).

The time during which receive signals are received from the sensing head 1 and processed by the processing unit 3, illustrated by waveform 32, can be effected by a transmit/receive switch when the magnetic field transmitter and the magnetic field receiver are the same element (e.g. a single coil is used as the magnetic field transmitter and the magnetic field receiver), and that the transmit/receive switch switches the element to the receive electronics in accordance to waveform 32 where a high level of waveform 32 indicates switching to receive electronics. However, a transmit/receive switch is not necessary when the magnetic field transmitter and the magnetic field receiver are different elements, and waveform 32 merely indicates a region where it is suitable for receiving and processing a receive signal and waveform 35 indicates a suitable region for communicating a communication signal.

In an embodiment, the communication between the additional sensor(s) 5 and the signal processing unit 3 occurs in windows 33 during which no receive signal is being processed by processing unit 3. This is achievable by having the communication signals between additional sensor(s) 5 and processing unit 3 synchronized with repeating transmit signal cycle 21. Such synchronized communication signal may occur with only a small delay after the transmission transitions. Nonetheless at least a small delay 36 is beneficial, but not necessary, as the transition from the zero-voltage period 29 to the low-voltage period 25 could perturb the communication signals between the additional sensor(s) 5 and the signal processing unit 3. Similarly, at least a small gap 37 is beneficial, but not necessary, when the low-voltage period 25 transitions to the high-voltage period 27.

The communication signal within windows 33 may be in many forms, for example, in burst-form as indicated by 34a, 34b and 34c. It is not necessary to have communication between the processing unit 3 and the additional sensors during each of windows 33. For example, no communication signal is communicated as indicated by 34d.

As the communication signals between the additional sensor(s) 5 and the signal processing unit 3 occurs during time when there is no processing, by the processing unit 3, of receive signals from the receiver within sensing head 1, the communication signals would not affect the processing of the receive signals.

In another embodiment, the transmit signal may take the form illustrated by FIG. 2b. As illustrated, this transmit signal 40 has a fundamental period 41, and includes a high-voltage period 42, a first low-voltage period 43 following the high-voltage period 42, a zero-voltage period 44 following the first low-voltage period 43, and a second low-voltage period 45 following the zero-voltage period 44. The characteristics, advantages, and production of transmit signal 40 is described in US2010/0148781. When transmit signal 40 is used for transmission, a receive signal is often received and processed during at least one of the low-voltage periods (43 or 45, or both), and possibly including part of the other periods. Accordingly, based on when the received signal is received and processed, the starting time and ending time and the sending of the communication signals are selected to avoid clashing with the receiving and processing of the receive signal.

In another embodiment, the transmit signal may take the form illustrated by FIG. 2c. As illustrated, this transmit signal 46 has a fundamental period 47, and includes a first low-voltage period 48, a first high-voltage 49 following the first low-voltage period 48, a first zero-voltage period 50 following the first high-voltage period 49, a second low-voltage period 51 following the first zero-voltage period 50, a second high-voltage 52 following the second low-voltage period 51, and a second zero-voltage period 53 following the second high-voltage period 52. The first low-voltage period 48, the first high-voltage period 49 are inverted forms of the second low-voltage period 51 and the second high-voltage period 52 respectively. However, it is possible to have slight variation between them. For example, the average voltage of the first high-voltage period 49 may not be exactly the same magnitude as the average voltage of the second high-voltage period 52. The characteristics, advantages, and production of transmit signal 46 is described in US2010/0141247. When transmit signal 46 is used for transmission, a receive signal is often received and processed during at least one of the zero-voltage periods (50 or 53, or both), and possibly including part of the other periods. Accordingly, based on when the received signal is received and processed, the starting time and ending time and the sending of the communication signals are selected to avoid interfering with the receiving and processing of the receive signal.

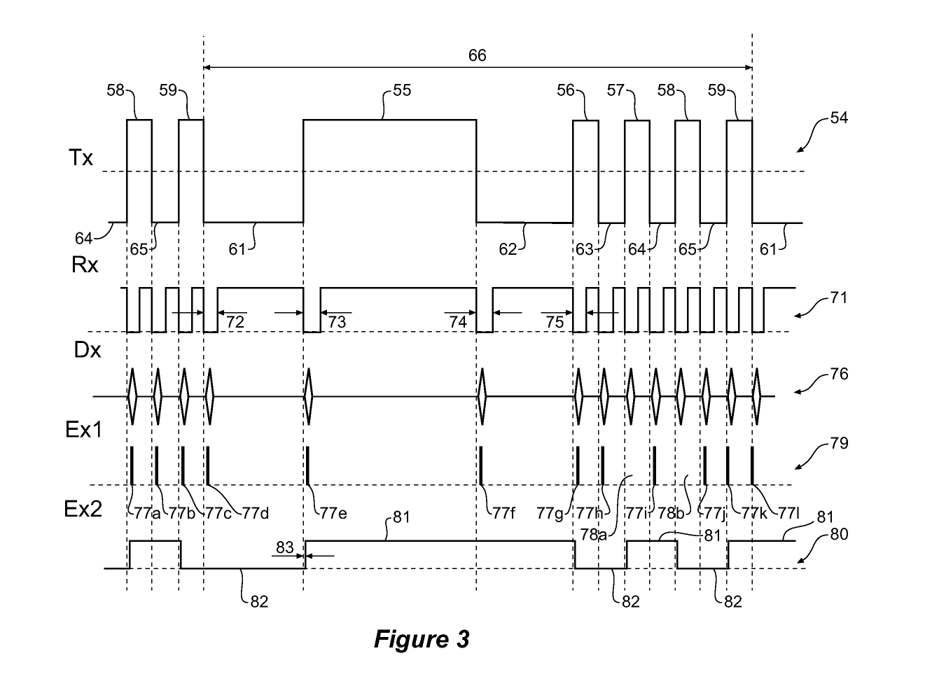

FIG. 3 depicts another embodiment of the present invention, the top waveform being the transmit signal (repeating transmit signal cycle 54) of a metal detector; the next waveform 71 illustrating the time during which receive signals from the sensing head 1 are processed by the processing unit 3; the next waveform 76 illustrating the suitable period for communicating communication signals between additional sensor(s) 5 and processing unit 3; the next two waveforms 79 and 80 illustrating examples of communication signals being communicated between additional sensor(s) 5 and processing unit 3.

With reference to FIG. 3, a metal detector transmits a repeating transmit signal cycle 54 with a fundamental period 66. Each fundamental period 66 includes one or more voltage periods of a first polarity and one or more voltage periods of a second polarity. In this example, a single transmit signal cycle includes positive polarity voltage periods 55, 56, 57, 58 and 59, and also includes negative polarity voltage periods 61, 62, 63, 64 and 65. Due to the nature of the repeating transmit signal cycle 54, the current through the transmitter is always changing throughout the repeating transmit signal cycle 54, and thus the metal detector is transmitting continuously throughout the entire repeating transmit signal cycle 54.

There are many ways to set the time windows for receiving receive signals from the sensing head 1. One exemplar is shown by waveform 71. In this exemplar, the processing unit 3, is almost always receiving and processing the receive signal from the sensing head 1 except during gaps such as 72, 73, 74 or 75 immediately after a transition of polarity of voltages. The gaps are beneficial as the transition of the transmit signal from a period with voltage of one polarity to a period with voltage of opposite polarity (for example, transition from voltage period 55 to voltage period 62 etc) could perturb the processing of the receive signal by the signal processing unit 3.

Gaps are often very short periods and thus each suitable period for communicating communication signals between additional sensor(s) 5 and processing unit 3 as shown by waveform 76 is very short. Accordingly, unlike the embodiment shown in FIG. 2a where the communication between additional sensor(s) 5 and processing unit 3 can occur in time windows 33 and may include several bits of information, it is not possible to have time windows with duration as long as that of time windows 33 for communication between additional sensor(s) 5 and processing unit 3. To overcome this problem, communication between additional sensor(s) 5 and processing unit 3 may be performed across several gaps (for example one bit at a time as illustrated by waveform 79 with spikes 77a, 77b, 77c, 77d, 77e, 77f, 77g, 77h, 77i, 77j, 77k and 77l) during which there is no processing of the receive signals as indicated by the gaps such as gaps 72, 73, 74 and 75. Any of the spikes is just an indication that there is a communication of one bit of data which can take a form representing zero or one.

Data collected over some or many short intervals may then be combined to form meaningful information and/or instructions. Not all gaps are necessarily used for sending a communication signal. For example, some gaps may be intentionally left vacant 78a and 78b. There may be also occasions that there is no communication signal to be communicated. Spikes 77a, 77b, 77c, 77d, 77e, 77f, 77g, 77h, 77i and 77j are shown to be sent within the gaps. As the timing of transmit signal 54 may be made known to the sensor(s) 5 and processing unit 3, the sensor(s) 5 and processing unit 3 may communicate communication signals at the edge or at the beginning of a gap, as shown in FIG. 3 as spikes 77k and 77l.

Another example of a communication signal communicated between additional sensor(s) 5 and processing unit 3 is shown as waveform 80. In contrast with spikes 77a, 77b, 77c, 77d, 77e, 77f, 77g, 77h, 77i, 77j, 77k and 77l where each spike represents one bit (which can be a one or a zero) in a data stream, waveform 80 represents a voltage level which communicates a one (when the waveform 80 is high 81) or a zero (when the waveform 80 is low 82). Such waveform 80 is particularly suitable to send data when the transmit signal 54 is used as a clock, as the voltage transitions can be constrained to the gaps. In one embodiment, the state of waveform 80 is updated when the transmit signal transitions from a negative polarity voltage period to a positive polarity voltage period. By communicating the state of waveform 80, a string of meaningful binary signals can be communicated between additional sensor(s) 5 and processing unit 3. In another embodiment, it is possible to have the state of waveform 80 updated when the transmit signal transits from a positive polarity voltage period to a negative polarity voltage period.

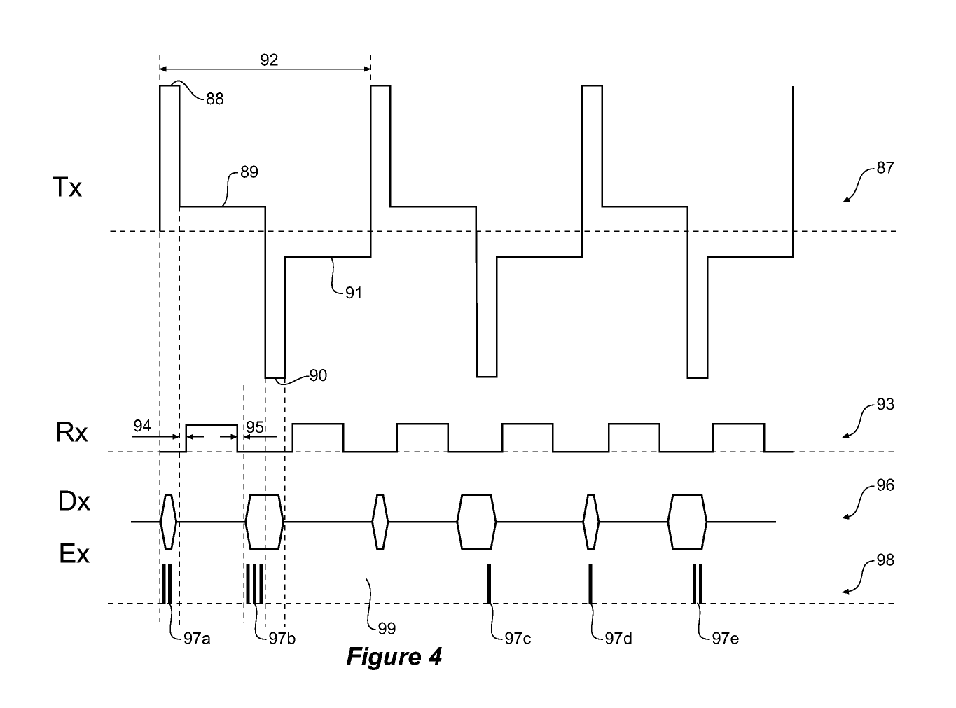

FIG. 4 depicts another embodiment of the present invention where the communication signals representing meaningful information or instructions may be sent over many short intervals, the top waveform being the transmit signal (repeating transmit signal cycle 87) of a time domain metal detector; the next waveform 93 illustrating the time during which receive signals from the sensing head 1 are processed by the processing unit 3; and the next two waveforms 96 and 98 illustrating the suitable period for communicating communication signals between additional sensor(s) 5 and processing unit 3, and communication signals communicated between additional sensor(s) 5 and processing unit 3 over many short intervals respectively.

With reference to FIG. 4, a metal detector transmits a repeating transmit signal cycle 87 with a fundamental period 92. Each fundamental period includes a first high-voltage period 88 of a first polarity (in the example shown in FIG. 4, positive polarity), a first low-voltage period 89 of the first polarity, a second high-voltage period 90 of a polarity opposite the first polarity (in the example shown in FIG. 4, negative polarity), and a second low-voltage period 91 of a polarity opposite the first polarity.

It is possible, but not necessary, to adjust the duration and/or magnitude of the low-voltage periods 89 and 91 and the duration and/or magnitude of the high-voltage periods 88 and 90 such that the current through the transmitter is maintained to be substantially non-zero throughout the repeating transmit signal cycle 87. In other words, a metal detector using a repeating transmit signal cycle 87 for transmission may always be transmitting. The receive signals are processed during low-voltage periods 89 and 91. However, gaps 94 and 95 are often added which prevent receive signals from being processed throughout an entire low-voltage period. The gaps 94 and 95 are beneficial, with 95 optional, as the transition from a high-voltage period to a low-voltage period, and vice-versa, could perturb the processing of receive signal by the signal processing unit 3.

Waveform 98 shows communication signals 97a, 97b, 97c, 97d and 97e communicated between additional sensor(s) 5 and processing unit 3 over many short intervals of high-voltage periods or at the end of each of the receive periods of waveform 93 but before the transitions to the high-voltage periods 88 or 90. The width of the gaps for example 94 or 95 can also be adjusted to provide more time for the communication signals 97a, 97b, 97c, 97d and 97e. Similarly with the embodiments discussed with reference to FIG. 3, not all available time is necessarily used for sending a communication signal. For example, some available time may be intentionally left vacant 99. There may also be occasions where there is no communication signal to be communicated.

In one embodiment, the receive signal may also be processed during the high-voltage periods 88 and 90. In such cases, the starting time and ending time of communication signals 97a, 97b, 97c, 97d and 97e are selected so that they are not falling within a time period when the receive signal is processed, whether the time period is within the high-voltage period 88 and 90, low-voltage periods 89 and 91, or spans across multiple periods.

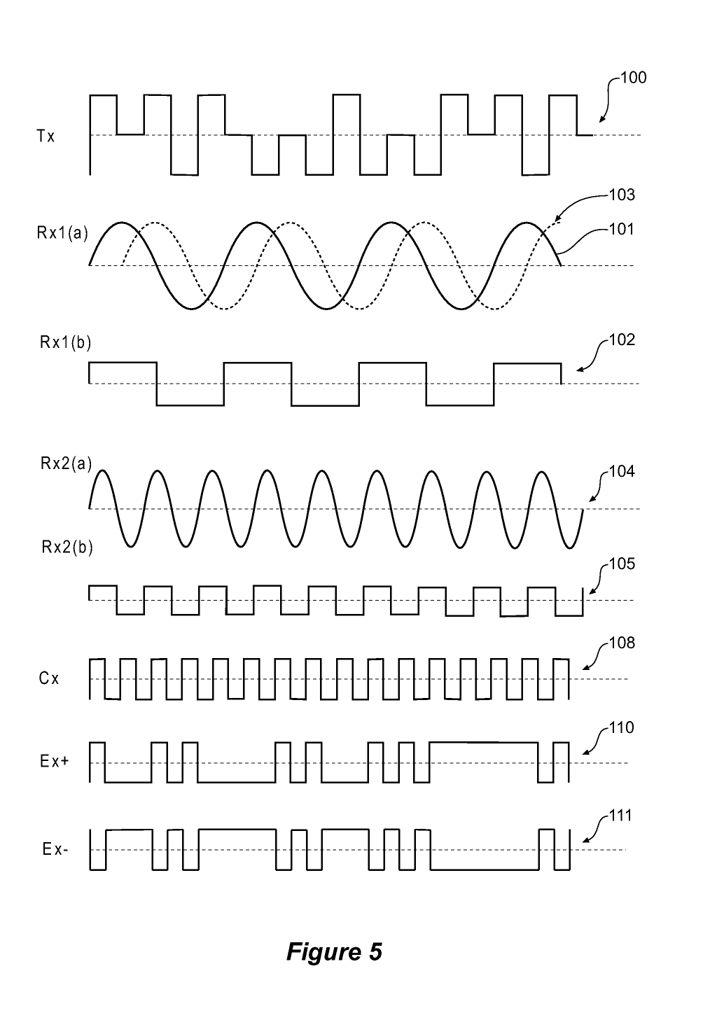

FIG. 5 depicts another embodiment of the present invention. In this embodiment, the transmit signal, which may or may not be a repeating transmit signal cycle with a fundamental period, includes periods of positive voltage, periods of negative voltage and periods of zero voltage. The periods may be configured such that there is always transmission from the transmitter within sensing head 1. In this example, the transmit signal 100 is a multi-frequency transmit waveform which includes more than one predominant frequency component. In one embodiment, there are four predominant frequency components at four different frequencies.

It is possible to perform a synchronous demodulation of the receive signal using sinusoidal waves (for example, 101, 103 and 104), or using continuous rectangular waves (for example, 102 and 105). The term continuous implies that there is no “gap” in demodulation, or in other words, the processing unit 3 is always processing receive signals from sensing head 1.

The term synchronous demodulation means that the frequency of the sinusoidal waves used during demodulation coincides with one of the frequencies where predominant frequency components of the transmit signal are located. For example, if a multi-frequency transmit waveform has predominant frequency components at frequencies f₁, f₂, f₃ and f₄, sinusoidal waves of frequency f₁, f₂, f₃ and f₄ or rectangular waves of fundamental frequency f₁, f₂, f₃ and f₄, can be used to demodulate the receive signal. In one form, each frequency is demodulated in-phase (for example, using sinusoidal wave 101) and in-quadrature (for example, using sinusoidal wave 103). Not shown, corresponding in-quadrature forms of in-phase waves 102, 104 and 105 can also be used concurrently during demodulation.

In such a case, a communication signal sent between the additional sensor(s) 5 and the processing unit 3 can be in a form having predominant frequency components at frequency higher or lower than the frequencies where the predominant frequency components of the transmit signal are located. As the demodulation of the receive signal only occurs at the frequencies where the predominant frequency components of the transmit signal are located, interferences caused by the communication signal may be minimised, if not avoided.

In one embodiment, the harmonics of the predominant frequency components of the communication signal are also at frequency higher or lower than the frequencies where the predominant frequency components of the transmit signal are located.

One example of the communication signal between additional sensor(s) 5 and the processing unit 3 is shown as 110.

For example, in accordance US2009/0318098, a multi-frequency transmit signal can be generated to have predominant frequency components at frequencies 1.216 kHz, 3.647 kHz, 10.943 kHz and 32.830 kHz. In such a case, communication signals can be communicated at a frequency of 3.000 kHz to reduce interference. If the transmitted predominant frequencies are fᵢ and the predominant frequency of the communication signal is f₀, then the choice of f₀ is such that it avoids satisfying the relation m·fᵢn·f₀, for any integer values of m and n, or at least for low integer values.

In one embodiment, the processing unit 3 generates a clock sequence (for example, 108 in FIG. 5) for the communication between the processing unit 3 and additional sensor(s) 5, and the additional sensor(s) 5 will synchronise their communication to this clock. Alternatively, the additional sensor(s) 5 can generate the clock sequence for transmitting the communication signal and the processing unit 3 will synchronise its communication to this clock. In another embodiment, there is no transmission of clock sequence (asynchronous communication). Rather, each part of the metal detector which requires a clock sequence generates its own clock sequence internally.

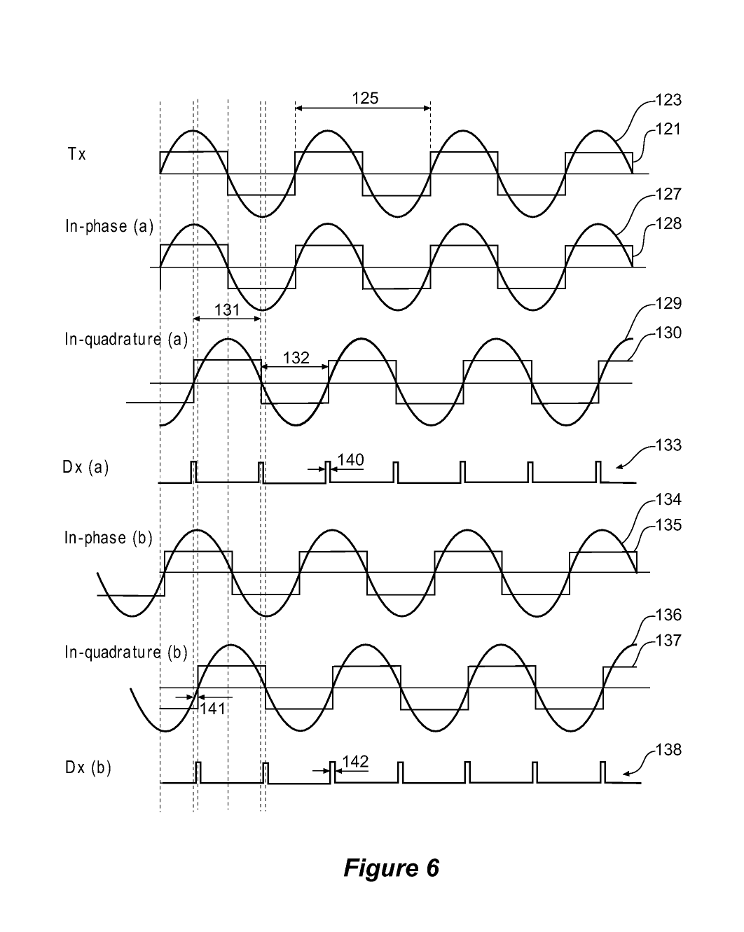

FIG. 6 depicts another embodiment of the present invention of which the metal detector transmits either rectangular waveform 121 or sinusoidal waveform 123 of fundamental period 125. The following description generally refers to the sinusoidal waveform 123, but the following description is also applicable to the rectangular waveform 121.

Similar to the embodiment described with reference to FIG. 5, the receive signal can be demodulated using an in-phase sinusoidal wave 127 and an in-quadrature sinusoidal wave 129. The sinusoidal waves 127 and 129 define demodulation windows of different signs (or polarity). Considering the in-quadrature sinusoidal wave 129 for example, during the duration 131, the demodulation window which includes a half-sinusoidal wave is of positive sign (or polarity), and during the duration 132, the demodulation window (which includes another half-sinusoidal wave) is of negative sign (or polarity). In one other form, a transmit wave is a rectangular wave 121, or that the demodulation functions is rectangular waves (128 and 130).

With reference to FIG. 6, it is possible to synchronise the communication windows between the additional sensor(s) 5 and the processing unit 3 with the transmitted frequency of either the rectangular waveform 121 or sinusoidal waveform 123, and arrange the phase of the communication signal 133 occurring during the communication windows 140 to be such that the interference caused by the communication signals to the receive signals is minimised. For example, the communication between the additional sensor(s) 5 and the processing unit 3 can occur about the transition from a demodulation window of a sign to another demodulation window of another sign. For example, communication can occur near the end of duration 131 or near the beginning of duration 132. This way, the effect on the in-quadrature signal is minimised, at the expense of the interference potential on the in-phase signal. However, since the detection of the conductive targets in mineralised (magnetic) soils is primarily based on the in-quadrature signals, there is no effect of the communication signals on the performance of the detector. If the detector is operated in saline environments (beach), it might be advantageous to shift the phase of the communication window such that the interference is minimised on the in-phase signal, even though this means potential interference on the in-quadrature signal.

In one embodiment, communication occurs from just before the end of duration 131 to just after the beginning of duration 132. In one form, the duration of the communication during the demodulation window of a sign, and the duration of the communication during the next demodulation window of the opposite sign is the same such that even the communication signals are demodulated, they will be cancelled out during further processing (for example by an integrator or low-pass filter).

FIG. 6 also illustrates the effect of taking into consideration the characteristics of the ground during processing. The effect of the ground can be compensated in ways known to a person skilled in the art. One way is to time-shift the demodulation functions (for example, by a time amount 141 and the resulting in-phase and in-quadrature sinusoidal waves 134 and 136, or in-phase and in-quadrature rectangular waves 135 and 137). Should such compensation be in place, the timing of the communication between processing unit 3 and additional sensor(s) 5 is also time-shifted by that amount. Another way is to first demodulate the receive signal using in-phase and in-quadrature waves (not time-shifted) and then apply a function to the output of the demodulation in software to compensate the ground effect, for example, by applying a rotation matrix which corresponds to the time-shift. In either case, the communication windows 140 of communication signal 133 need to be shifted accordingly, for example, as illustrated by the time-shifted communication windows 142 of communication signal 138.

With respect to the embodiments described above, it may be advantageous to use differential digital signalling even though this requires more connections (for example, two physical line connections instead of one). For example, communication signal 110 (in FIG. 5) and its corresponding inverting form 111 may be communicated between additional sensor(s) 5 and processing unit 3 using two physical line connections. In one embodiment, the two physical line connections are twisted pair of wires.

It is also possible to sacrifice some of the data throughput and send for each bit value an inverted bit value, and thus provide some degree of digital signal cancellation. This will not eliminate the interference completely, but it could reduce it to an acceptable level.

With respect to all embodiments described herein, separate ground and or power supply connections will further reduce the likelihood of interference.

In the case where the receiver of the sensing head is a coil, the interference may be coupled magnetically between the digital section on the printed circuit board and the coil. Such coupling can be reduced by redesigning the printed circuit board to reduce loops on the printed circuit board which couple with the receive winding. An alternative is to physically position the printed circuit board in a plane perpendicular to the plane of the coil.

A detailed description of one or more preferred embodiments of the invention is provided above along with accompanying figures that illustrate by way of example the principles of the invention. While the invention is described in connection with such embodiments, it should be understood that the invention is not limited to any embodiment. On the contrary, the scope of the invention is limited only by the appended claims and the invention encompasses numerous alternatives, modifications, and equivalents. For the purpose of example, numerous specific details are set forth in the description above in order to provide a thorough understanding of the present invention. The present invention may be practiced according to the claims without some or all of these specific details. For the purpose of clarity, technical material that is known in the technical fields related to the invention has not been described in detail so that the present invention is not unnecessarily obscured.

Throughout this specification and the claims that follow unless the context requires otherwise, the words ‘comprise’ and ‘include’ and variations such as ‘comprising’ and ‘including’ will be understood to imply the inclusion of a stated integer or group of integers but not the exclusion of any other integer or group of integers.

The reference to any prior art in this specification is not, and should not be taken as, an acknowledgment or any form of suggestion that such prior art forms part of the common general knowledge of the technical field.

1. A method for improving a performance of a metal detector, comprising:
generating a transmit signal;
generating a transmit magnetic field based on the transmit signal for transmission using a magnetic field transmitter;
sending a receive signal based on a receive magnetic field received by each of one or more magnetic field receivers to a processing unit of the metal detector;
sending a communication signal, including information from one or more sensors different from the one or more magnetic field receivers, to the processing unit; and
processing the receive signal with the communication signal to produce an indicator output signal indicating a presence of a target under an influence of the transmit magnetic field;
wherein one or more characteristics of the communication signal are selected based on the transmit signal to reduce or avoid an interference of the communication signal to the receive signal.

2. The method of claim 1, wherein the one or more characteristics of the communication signal include a starting time of the communication signal.

3. The method of claim 2, wherein the transmit signal defines a suitable period for the step of sending the communication signal to the processing unit to reduce the interference of the communication signal to the receive signal, and wherein the starting time of the communication signal is within the suitable period.

4. The method of claim 3, wherein the one or more characteristics of the communication signal includes an ending time of the communication signal, and wherein the ending time of the communication signal is within the suitable period.

5. The method of claim 3 or 4, wherein during the suitable period, the processing unit is not processing the receive signal.

6. The method of claim 5, wherein the transmit signal includes a transmit period and a zero-transmit period; and the processing unit processes the receive signal during a part of the zero-transmit period.

7. The method of claim 6, wherein the zero-transmit period includes the suitable period.

8. The method of claim 6, wherein the transmit period includes a low-voltage period and a high-voltage period; and the low-voltage period includes the suitable period.

9. The method of claim 5, wherein the transmit signal includes a voltage period of a first polarity and a voltage period of a second polarity, the second polarity is opposite the first polarity; and the processing unit processes the receive signal after a predetermined delay from the transition of the voltage period of one polarity to the voltage period of opposite polarity.

10. The method of claim 9, wherein the predetermined delay includes the suitable period.

11. The method of claim 5, wherein the transmit signal includes a high-voltage period and a low-voltage period; and the processing unit processes the receive signal during a part of the low-voltage period after a predetermined delay from the transition of the high-voltage period to the low-voltage period

12. The method of claim 11, wherein the high-voltage period includes the suitable period.

13. The method of claim 11, wherein the low-voltage period includes the suitable period.

14. The method of claim 3 or 4, wherein the processing unit processes the receive signal using a continuous synchronous demodulation function which includes a positive demodulation window and a negative demodulation window; and wherein a period about a transition of a demodulation window to another includes the suitable period.

15. The method of claim 14, wherein the suitable period overlaps substantially the same duration with the positive demodulation window and the negative demodulation window.

16. The method of claim 1, wherein the one or more characteristics of the communication signal includes characteristics of one or more predominant frequency components of the communication signal.

17. The method of claim 16, wherein one or more of the predominant frequency components of the transmit signal are at frequencies different from that of predominant frequency components of the communication signal.

18. The method of claim 17, wherein harmonics of the predominant frequency components of the transmit signal are at frequencies different from that of harmonics of the predominant frequency components of the communication signal.

19. The method of claim 1, further including:
updating a state of the communication signal during a suitable period defined by the transmit signal to reduce an interference to the receive signal caused by the updating.

20. A metal detector configurable to perform the method of any one of claims 1 to 19.
